(19) United States
(12) Patent Application Publication
(10) Pub. No.: US 2008/0031435 A1
(43) Pub. Date: Feb. 7, 2008

(54) Remote control system

(75) Inventors: Yasuo Kagaya, Tokyo (JP); Kenji Mukaida, Tokyo (JP)

Correspondence Address: PILLSBURY WINTHROP SHAW PITTMAN, LLP, P.O. BOX 10500, MCLEAN, VA, 22102, US

(73) Assignee: Nikko Co., Ltd., Tokyo (JP)

(21) Appl. No.: 11/729,906

(22) Filed: Mar. 30, 2007

(30) Foreign Application Priority Data
Mar. 30, 2006 (JP) 2006-094252

(51) Int. Cl. H04M 11/00

(52) U.S. Cl. 379/102.01

(57) ABSTRACT

Radio control over a distance beyond the arriving distance of the conventional radio control and transmission of the continuous instruction signal on the real time are possible. The system provides DTMF signal generation means for modulation of a control signal for controlling a controllable section into DTMF signal, VOIP transmission means for receiving DTMF signal to generate VOIP signal for transmission to VOIP line, VOIP line capable of transmitting VOIP signal, VOIP receiving means for receiving VOIP signal for conversion into DTMF code, DTMF demodulation and retransmission means for conversion of regenerated DTMF signal into a radio control transmission signal and a controllable section for receiving the radio control transmission signal and the signal generated by DTMF signal generation means is driven by DTMF demodulation and retransmission means through VOIP line in order to control the receiving means.

This application claims the benefit of priority of Japanese Patent Application No. 2006-094252, filed Mar. 30, 2006, the entire contents of which are incorporated herein by reference.

### BACKGROUND OF THE INVENTION

1. Field of the Invention

This invention relates to a radio-controlled remote control system through an internet network line.

2. Description of the Related Art

The conventional radio control system of toys such as radio-controlled-car, for example, is operated in use of an electromagnetic wave such as an infrared ray or an electric band of 27 MHz and 40 MHz within visible area. This is convenient system for the players who may operate the system in the visible area.

According to the latest considerable propagate of the internet online network, however, the remote control over far long distance is realized and the remote control by internet and the remote control by radio control are infused, for example, as proposed in the patent publication 1.

The patent publication 1 discloses a remote control system operable by means of a wireless LAN. Particularly, the patent publication 1 is concerned with a remote control multiplex transmission system that multiplexes and transmits control signals for controlling a number of process machines at a reduced cost, where a radio control operating device which controls a plurality of radio controllers and a radio control transmitter which transmits the radio control signal are connected to LAN connection board respectively and each LAN connection board is connected through a hub and a wireless LAN. Thus, transmission without relying on arriving distance of the radio control transmission may take place with convenient multiplex transmission for controlling a plurality of radio controls. See Japanese Patent Laid-Open Publication No. 2001-61192

### SUMMARY OF THE INVENTION

There is, however, an issue to be caused due to differences between transmissions through an internet of various bases and transmission through a radio control of a single base. In the radio control transmission, simultaneous transmissions from a common base through the same frequency might be impossible on account of interferences among the signals. When the signals are impeded together, retransmission of the signals is needed to repeat until the desired arrival is attained even with some delay in transmission through the internet.

The radio control system is applied for transmission of the signal of the real automobile car and the retransmission of the signal likely causes the repeated transfers of the instructions, for which reason it is required to provide a remote control system where an instruction in which an operation signal corresponds one by one to another operation signal on the real time operation may positively be received by the receiving station.

A purpose of the invention is, therefore, to provide a remote control system where a radio control distance beyond the arrival distance of the conventional radio control measure is obtained.

The first aspect according to the invention is directed to a remote control system which provides DTMF signal generation means for modulating a control signal which controls a controllable section into DTMF signal, VOIP transmission means for receiving DTMF signal to generate VOIP signal for transmission to VOIP line, VOIP line which may transmit VOIP signal, VOIP receiving means to receive VOIP signal for conversion into DTMF code, DTMF demodulation retransmission means for conversion of the regenerated DTMF signal into a transmission signal for the radio control signal and a controllable section to receive a transmission signal for the radio control signal for operation and the signal generated by DTMF signal generation means is driven by DTMF modulation retransmission through VOIP line.

DTMF modulation retransmission may provide a radio receiver of different band for receiving the signal issued from a radio receiver of different band provided in the controllable section.

VOIP transmission means may be provided with a predetermined interval for the delayed signal to transmit signals.

### BRIEF DESCRIPTION OF THE DRAWINGS

The above and other objects, features, and advantages of the present invention will be made more apparent from the description of the preferred embodiments with reference to the accompanying drawings wherein:

FIG. 1 is a block diagram of the remote control system according to the invention.

FIG. 2 is a block diagram of the remote control system according to the invention.

### DETAILED DESCRIPTION OF THE INVENTION

According to the remote control system of the invention, the radio control beyond the normal arriving distance of the radio control may be performed and further the continuous instruction signals may be transmitted on the real time operation.

A typical mode for embodying the invention shall be described with reference to the accompanying drawings.

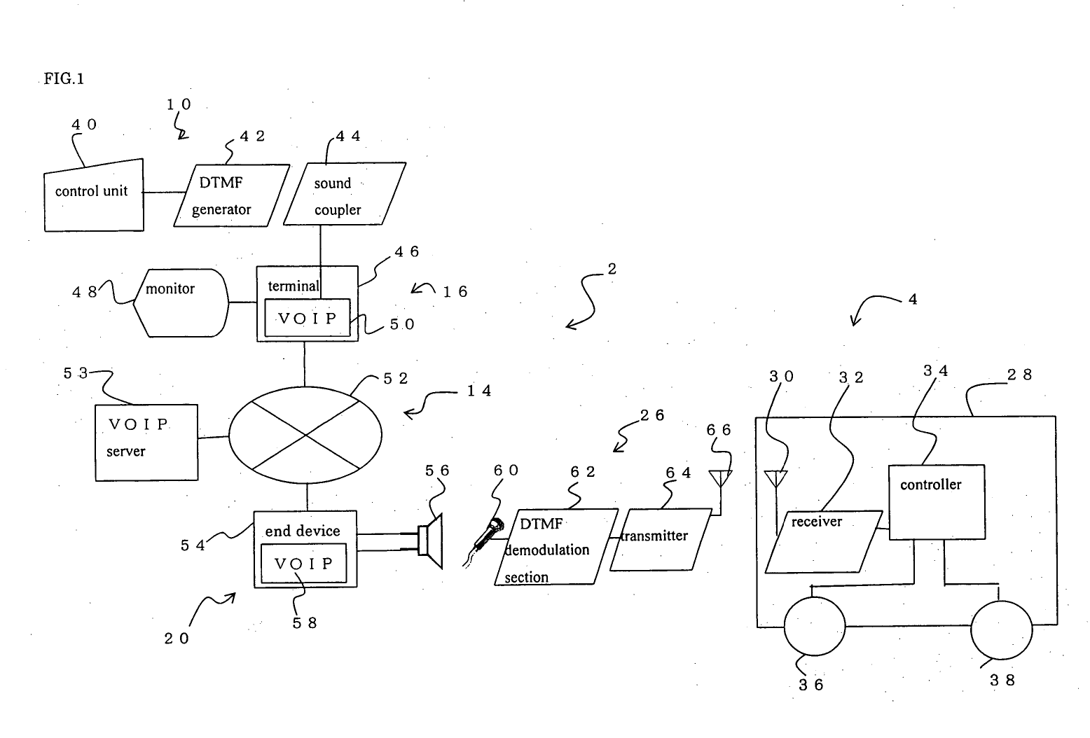

A first embodiment of the remote control system 2 according to the invention shall be illustrated in FIG. 1 of the accompanying drawings.

The remote control system 2 according to the invention is comprised of DTMF signal generation means 10 for modulating the control signal 6 which controls the controllable section 4 into DTMF or Dual-T one Multi-Frequency signal 8, VOIP transmission means 16 to receive DTMF signal 8 for generation of the VOIP signal 12 and transmission to VOIP line, VOIP line 14 which may transmit VOIP signal 12, VOIP receiving means 20 for receiving VOIP signal 12 for conversion into DTME code 18, DTMF demodulation retransmission means 26 for conversion of regenerated DTMF signal 22 into the radio control transmission signal 24 and a controllable section 4 for receiving the radio control transmission signal for operation of the unit.

The controllable section 4 comprises a car model as an example and a car body 28 is provided with a receiver 32 associated with an antenna, a controller 34 and tires 36, 38. In accordance with a signal received by an antenna 30 and a receiver 32, the controller 34 controls the drivings or directions of the tires 36 and 38.

DTMF signal generation means 10 includes a controller 40 and DTMF generator 42. The controller 40 provides an operation unit for driving and an operation unit for steering and also an operation switch for advancement, backwardness, light turn and left turn. Further, a transmission unit may be provided for transmitting the signal by modulating an electric wave band or an electromagnetic wave such as infrared rays.

DTMF generator 42 has a function of modulating the signal of the controllable section 40 into DTMF signal determined by ITU-T Notic Q 24 containing sixteen tones. In case the controller 40 provides a switch only, DTMF generator 42 applies for four kinds of tones identified by the references (1), (2)-(C), (D) including advancement, backwardness, light turn and left turn. Four tones may selectively be formed of a higher group tone of 1209 Hz, 1336 Hz, 1477 Hz and 1633 Hz and a lower group tone of 697 Hz, 770 Hz, 852 Hz and 941 Hz.

In case the controllable section 40 generates an electromagnetic wave, provision is made of a receiving unit of the electromagnetic wave and DTMF generating unit for receiving the electromagnetic wave to generate DTMF tone.

VOIP transmission means 16 is provided at its terminal 46 a sound coupler 44 and a monitor 48. The terminal 46 comprises a computer unit with a memory for storing therein VOIP software 50 to be associated with a telephone line on the internet and the sound coupler 44 and the monitor 48 are connected to the terminal 46 respectively. The terminal 46 is connected directly or through the servers such as LAN card, hub, rooter, provider and the like to the internet 52.

The sound coupler 44 incorporates a microphone for catching DTMF tone generated by DTMF generator 42 to input an analog signal into the terminal 46.

The monitor 48 is a display unit for inspecting necessary information when the terminal 46 is controlled.

VOIP line 14 includes an internet line 52, VOIP sever 53 and their lines to the severs like the providers. VOIP line 14 physically employs the internet line to constitute a communication system with an interactive communication protocol SIP so that each communication terminal on the network opens session. Particularly, VOIP server 53 works as a SIP server or registrar server to register each client end device information including IP address, user name, waiting port numbers, expirations which are usually referred to when the user tries to renew or remove the registrations on the client end device.

VOIP receiving means 20 is comprised of an end device 54 and a speaker 56. The end device 54 incorporates therein VOIP software 58 and is connected to a speaker 56 and DTMF code 18 received by the end device 54 is reproduced from the speaker 56 as DTMF signal 22.

VOIP software 50 of the end device 46 receives the signal from the sound coupler for transmission of the sound signal or INVITE to VOIP server 53 through VOIP line where an information of the sound end device 46 and an information of the end device 54 are transmitted.

VOIP server 53 determines a position information of the end device 54 for relay to the end device 54.

VOIP software 58 of the end device 54 transmits OK signal upon receipt of the sound signal or INVITE via VOIP server 53.

VOIP server 53 relays the OK signal to the end device 46.

VOIP software 50 of the end device 46 receives OK signal and transmits ACK signal to VOIP server 53.

VOIP server 53 relays ACK signal to the end device 54.

VOIP software 58 of the end device 54 opens the line.

VOIP software 50 of the end device 46 opens for transmission of DTMF signal.

DTMF demodulation retransmission means 26 is comprised of a microphone 60, DTMF demodulation section 62, a transmitter 64 and an antenna 66. The microphone 60 is connected to DTMF demodulation section 62 and DTMF demodulation section 62 is connected to the transmitter 64 which is in turn connected to the antenna 66. The microphone 60 collects DTMF signal 22 reproduced by the speaker 56. DTMF demodulation section 62 demodulates DTMF signal 22 collected by the microphone 60 for transmission to the transmitter 64 which generates a radio control transmission signal 24 for transmission to perform the radio control.

The controllable section 4 receives the radio control transmission signal 24.

A function of the remote control system according to the invention shall be explained hereinafter.

The signal input from the operation station to the controllable section 40 is transmitted to DTMF generator 42 for conversion into DTMF signal 8 which is then collected by the sound coupler 44 output from the DTMF generator 42 as a sound signal.

The end device 46 modulates the signal from the sound coupler 44 into VOIP signal for conversion into the sound signal on the internet and subsequent transmission to the end device 54 through VOIP line 14 and VOIP server 53. It is preferable to take place the transmission in anticipation of the signal delay of 50 msec to 1 min. Namely, an instruction is transmitted with an interval of 50 msec-1 min, while the receiving section receives the instructions with 50 msec-1 min interval delay. For this purpose, the software may provide the timer program or the timer circuit may be arranged in the transmission and reception.

The end device 54 demodulates VOIP signal 12 into DTMF signal 22 for output through the speaker 56.

DTMF demodulation section 62 collects DTMF signal 22 by the microphone 60 for demodulation to an operation signal.

The transmitter modulates the operation signal into the radio control signal 24 for transmission through the antenna 66.

A receiver 32 of the car model or the controllable section 4 receives the radio control transmission signal 24 through the antenna 30 for transmission of the signal to the controller in order to actuate the car model.

On account of the foregoing operations, the undesired retransmission of the signal is extremely reduced so that a real time control in the radio control is positively. ensured.

On account of application of DTMF, the resistability against the noise is relatively elevated.

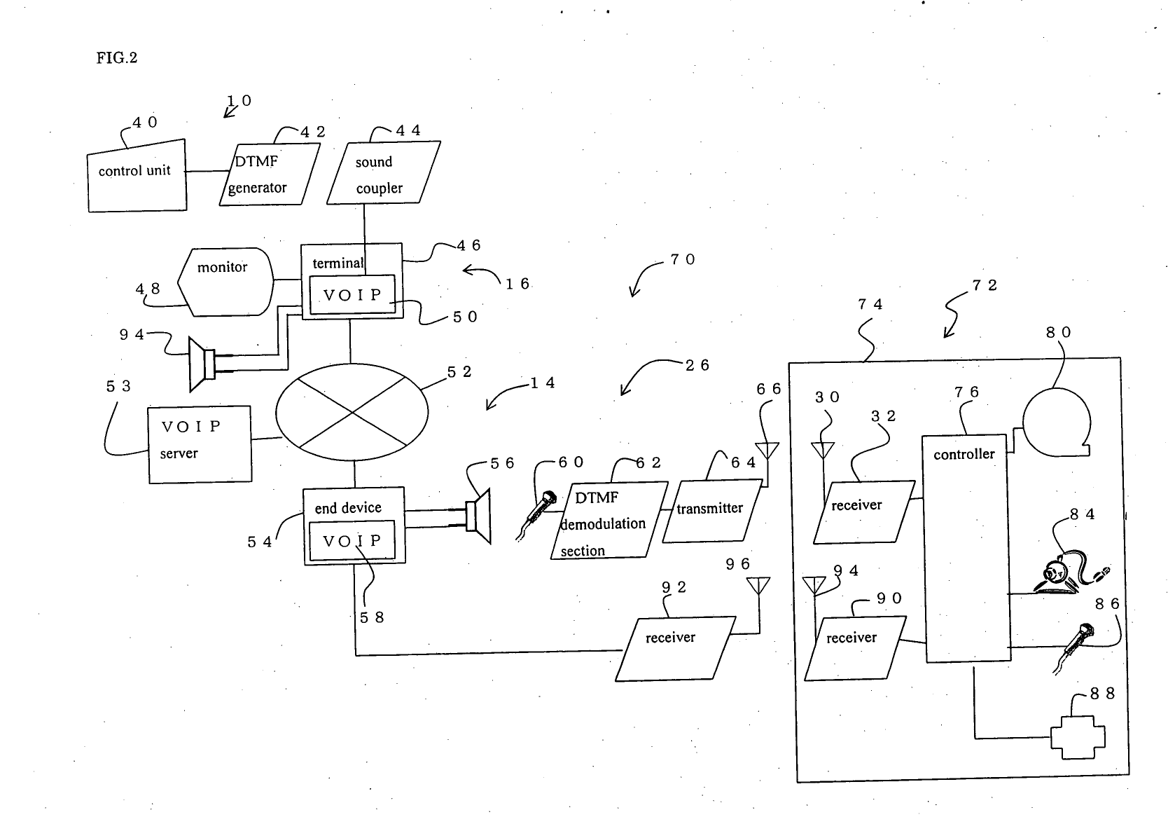

The second embodiment of the remote control system 2 according to the invention is illustrated in FIG. 2 of the accompanying drawing.

The remote control system 70 of the second embodiment is provided with another arrangement which will be described in the followings.

The second embodiment is most characterized in that the controllable section 72 comprises a remote control monitoring camera 74 providing a microphone and a sensor.

The remote control monitoring camera 74 with the microphone and the sensor is internally provided with a controller 76 which in turn is provided with a camera driving motor 80, a camera 84, a microphone 86 and a sensor 88 of thermometer, hygrometer, barometer, compass, oscillometer, sound detector, gas sensor, and flame detector.

The controller 76 is connected to the receiver 32 and ISM band SS radio transmitter 90.

To the end device 58 are connected the transmitter 64 and ISM band SS radio receiver 92.

Further, the end device 46 is provided with a speaker 94.

An operation of the second embodiment of the remote control system 2 according to the invention shall be described in the followings.

An operation from the control unit 40 including modulation and demodulation of DTMF to the receiver 32 is substantially the same one.

The control unit 40 transmits the control signals with DTMF not only to the camera driving motor 80 but also to the camera 84, the microphone 86 and the sensor 88 for controlling.

The controller 76 transmits to ISM band SS radio receiver 92 image data and sound data from the camera 84, the microphone 86 and the sensor 88 in the form of the signal of the controller 40 through ISM band SS radio transmitter 90, an antenna 96 and an antenna 98 with further transmissions from the end device 54 through the internet 52 to the end device 46 for display on the monitor 48.

Accordingly, an operation of the camera driving motor 80 by inspecting the image may ensure a more accurate control of the unit.

As example of the remote control system according to the embodiment of the present invention, a control unit for the car model comprising a driving control and an steering control has been described, but not limited to the car model and DTMF permits an output of 16 TONE with 16 sorts of the controls.

The full function control may be carried out only by an on/off operation of the motor. When, however, the receiver is controlled by DTMF, the operation items may be increased or the power capacity may be adjusted to control the motor velocity.

In the example described, SIP standard is proposed to apply for, notwithstanding ITUH 323, G.723.1, Wi-Fi standard and WiMAX, 802.20 standard may also be applicable.

With use of the remote control system 2 according to the invention, the remote control of the distance beyond the arrival distance of the radio control may be performed and a continuous instruction signal may be transmitted at the real time and the system may also be used for monitoring the houses or offices in absence and other inconvenient environments to which human access is difficult or impossible.

What is claimed is:

1. A remote control system comprising DTMF signal generation means for modulation of a control signal for controlling a controllable section into DTMF signal, VOIP transmission means for receiving DTMF signal to generate VOIP signal for transmission to VOIP line, VOIP line capable of transmitting VOIP signal, VOIP receiving means for receiving VOIP signal and converting into DTMF code, DTMF demodulation and retransmission means to convert regenerated DTMF signal into a radio control transmission signal and a controllable section for receiving a radio control transmission signal for actuation, wherein a signal generated in DTMF signal generating means is driven by DTMF demodulation and retransmission means through VOIP line in order to control the receiving means.

2. A remote control system according to claim 1, wherein DTME demodulation and retransmission means is provided with a radio receiver of another band for enabling to receive a signal from the radio transmitter of another band arranged in the controllable section.

3. A remote control system according to claim 1, wherein the VOIP transmission means is provided with a predetermined interval for a delayed signal to transmit signals.
